(19) United States
(12) Patent Application Publication
(10) Pub. No.: US 2026/0005965 A1
(43) Pub. Date: Jan. 1, 2026

(54) METHODS FOR ASSIGNING PROVIDER DEVICES AS DESIGNATED FORWARDERS FOR DIFFERENT VLANS

(71) Applicant: Ruckus IP Holdings LLC, Claremont, NC (US)

(72) Inventor: Kiran Kalidevapura Thimmappa, Bengaluru (IN)

(21) Appl. No.: 19/240,313

(22) Filed: Jun. 17, 2025

Related U.S. Application Data
(60) Provisional application No. 63/664,875, filed on Jun. 27, 2024.

(51) Int. Cl. H04L 45/76

(52) U.S. Cl. CPC H04L 45/76

(57) ABSTRACT

A method of forwarding traffic to a client edge (CE) device comprises using an ordered list of virtual local area network (VLAN) identifiers, where each VLAN identifier corresponds to a respective one of a plurality of VLANs, to assign, for each of the plurality of VLANs, one of a plurality of provider edge (PE) devices that are connected to the CE device to forward traffic that is within a class of traffic to the CE device.

### CROSS-REFERENCE TO RELATED APPLICATIONS

The present application claims priority under 35 U.S.C. § 119 to U.S. Provisional Patent Application Ser. No. 63/664,875 filed Jun. 27, 2024, the entire content of which is incorporated herein by reference.

### TECHNICAL FIELD

The present disclosure is related to networking systems and devices, and in particular is related to networking systems and devices configured to provide traffic drop solutions for mobile devices within the networking systems.

### BACKGROUND

Networking systems and computing devices are of increasing interest and importance. Networking systems include computing devices such as routers and switches that determine and direct data traffic through one or more networks of interconnected computing devices, such as local area networks (LANs), wide area networks (WANs), and/or the Internet. Switches are devices that operate at the data link layer, or layer 2 of the Open Systems Interconnection (OSI) networking model. A switch takes in or receives data from a first computing device connected to a first port of the switch, and then forwards/transmits the data to a second computing device connected to a second port of the switch. The first and second computing devices may be, as examples, computers, servers, printers, or other switches. Routers are computing devices at the network layer, or layer 3 of the OSI networking model. A router works to direct the flow of the data across the network, in part by choosing a route for the data. The data may be encapsulated in various containers at different layers in the networking model.

Networking systems and computing devices are being deployed in ever-increasing numbers in many different applications and fields. Increasingly, different and varied types of networks and networking configuration techniques are available to provide computing devices at different physical sites or locations the ability to communicate with one another. For example, virtual networks such as virtual LANs (VLANs) and virtual private networks (VPNs) are used to group end-user computing devices, sometimes referred to as hosts.

VLANs partition and isolate network traffic logically while permitting the traffic to travel across a same physical structure, such as a LAN. For example, a laptop computer assigned to only a first VLAN can send a file to a printer also assigned to the first VLAN, but would not be able to connect to or access a server (e.g., one containing sensitive information) that is not assigned to the first VLAN and is instead assigned to a second VLAN. Networking devices that support VLAN operation apply tags to network frames and then handle the tagged network frames according to network configurations and/or settings, creating the appearance and functionality of network traffic that is physically on a single network but acts as if it is split between separate networks.

VPNs create secure connections over insecure or public networks, such as the Internet. The secure connections enable a remote computing device (e.g., a mobile phone in transit) to connect to and access a secure or private network and utilize resources available on the private network (e.g., an email server for an organization).

An Ethernet virtual private network (EVPN) is an advanced form of VPN that allows a group of dispersed client sites to be connected using a data link layer virtual bridge. An EVPN may include one or more client edge (CE) devices (e.g., routers, switches, etc.) connected to one or more provider edge (PE) devices (e.g., routers, switches, etc.). The CE devices may be associated with a first entity (e.g., a business) and the PE devices may be associated with a second entity (e.g., a telecommunications provider). The CE devices interconnect (e.g., via local networks) host devices, such as personal computers, servers, printers, Internet-of-Things devices, mobile phones and tables, and so on. The PE devices are at the edge of a provider network such as a packet switched network, which may use Multi-Protocol Label Switching (MPLS) and/or Internet Protocol (IP) infrastructure. EVPN uses Border Gateway Protocol (BGP) to distribute host Media Access Control (MAC) addresses over the provider network, which can help provide greater control and optimize the flow of data across the network. EVPN is being increasingly applied in different areas, including service provider applications, data center applications, and interconnect applications.

### BRIEF DESCRIPTION OF THE DRAWINGS

FIG. 1 is a block diagram of a simplified network according to some of the concepts described herein.

FIGS. 2A and 2B are block diagrams providing further simplification of the network of FIG. 1 and illustrate aspects of some of the concepts described herein.

FIG. 3 is a flowchart providing operations of a method according to some of the concepts described herein.

FIG. 4 is a block diagram of a simplified network and illustrates aspects of some of the concepts described herein.

FIG. 5 is a block diagram of a computer networking device according to some of the concepts described herein.

FIGS. 6, 7, 8, 9A, 9B, and 10 are block diagrams of simplified networks and illustrate aspects of some of the concepts described herein.

FIG. 11 is a block diagram of an electronic device according to the concepts described herein.

FIGS. 12A-12C are tables illustrating additional examples of the techniques according to embodiments of the concepts described herein.

### DETAILED DESCRIPTION

EVPN also supports multi-homed CE devices, permitting a single CE device to be connected to two or more PE devices at the same time. The connection between the multi-homed CE device and the two or more PE devices is via a set of lag links that are collectively referred to as an Ethernet segment (ES). The two or more PEs connected to a multi-homed CE device may be configured to act in an active-standby mode where only one PE device forwards traffic and the other PE devices serve as redundancy options in the case of failure of the active PE device, or in an active-active mode where all of the PE devices are able to transmit traffic to the multi-homed CE device.

EVPNs can carry VLAN tagged traffic and thus provide the benefits of VLAN partition and isolation for traffic between the dispersed client sites. One or more EVPN instances (EVIs) are provided, with each EVI including one or more CE devices that are connected to one or more PE devices.

Each broadcast domain (e.g., each VLAN) may be identified by a VLAN identifier (e.g., a string of characters, a numerical value, etc.).

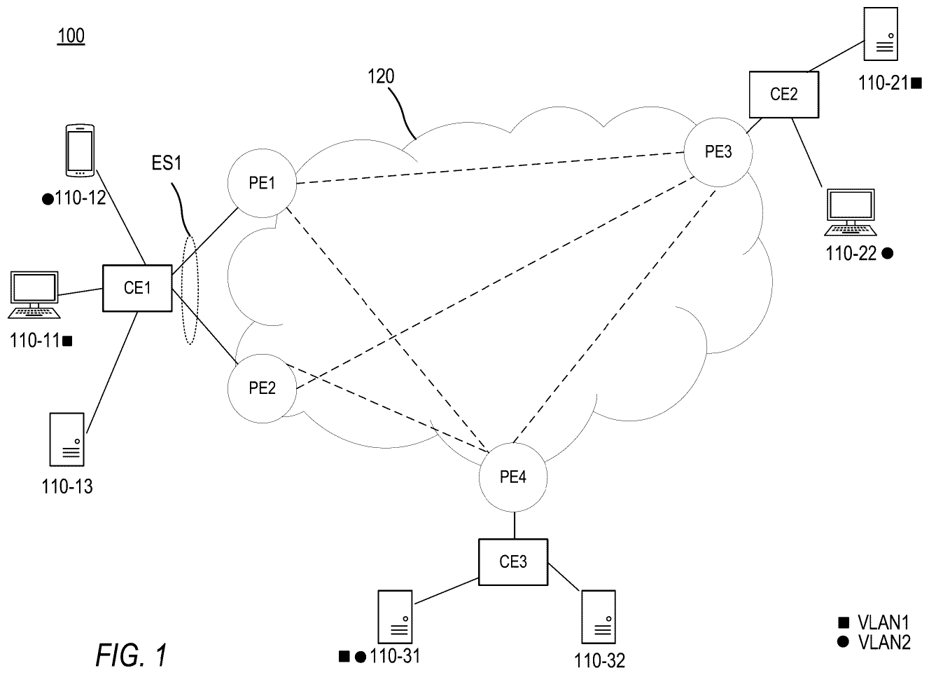

FIG. 1 is a block diagram of a simplified network 100 according to the concepts described herein. The simplified network 100 includes a plurality of CE devices (shown as first to third CE devices CE1, CE2), and CE3 and a plurality of PE devices (shown as first to fourth PE devices PE1, PE2, PE3, and PE4). The second and third CE devices CE2 and CE3 are each single-homed devices and connected respectively to the third and fourth PE devices PE3 and PE4. The first CE device CE1 is multi-homed with the first and second PE devices PE1 and PE2 via an Ethernet segment ES1. First to third host devices 110-11, 110-12, and 110-13 are connected to the first CE device CE1, fourth and fifth host devices 110-21 and 110-22 are connected to the second CE device CE2, and sixth and seventh host devices 110-31 and 110-32 are connected to the third CE device CE3. In some embodiments, the first to seventh host devices 110-11 to 110-32 are not directly connected to the corresponding first to third CE devices CE1 to CE3, and intermediate computer network devices (e.g., switches) may be present but are not seen in FIG. 1.

The first to fourth PE devices PE1 to PE4 are shown at edges of a provider network 120, with dashed links shown therebetween to indicate that other network infrastructure may be part of the provider network 120 but is not shown in FIG. 1.

A first VLAN VLAN1 (and a first EVI associated therewith) may be implemented on the network 100, and the first host device 110-11, the fourth host device 110-21, and the sixth host device 110-31 may communicate traffic with each other via the first VLAN1. A second VLAN VLAN2 (and a second EVI associated therewith) may also be implemented on the network 100, and the second host device 110-12, the fifth host device 110-22, and the sixth host device 110-31 may communicate traffic with each other via the second VLAN2. (The sixth host device 110-31 may thus be a member of both the first and second VLANs VLAN1 and VLAN2).

Each of the first to third CE devices CE1, CE2, and CE3 and the first to fourth PE devices PE1, PE2, PE3, and PE4 may be configured to communicate VLAN-tagged traffic for both the first and second VLANs VLAN1 and VLAN2.

Some traffic on the first and second VLANs VLAN1 and VLAN2 is unicast (or more specifically, known-unicast) traffic where a communication originates from a first host and is destined for and addressed to a second host. Other traffic, including broadcast, unknown-unicast, and multicast traffic (collectively referred to as BUM traffic) is not addressed to a single destination host.

Broadcast traffic is intended to be transmitted to any reachable destination in the network without the need to know any information about the receiving party. Unknown-unicast traffic occurs when a computer networking device such as a switch receives unicast traffic intended to be delivered to a destination that is unknown to the computer networking device. Multicast traffic originates from a first host and is directed to one or more hosts or devices that have joined a multicast group.

At the data link layer, VLAN-tagged BUM traffic may be flooded, and sent to all ports that have an association with the VLAN. For example, using the simplified network 100 of FIG. 1, VLAN-tagged BUM traffic for both the first and second VLANs VLAN1 and VLAN2 may be transmitted and received at the first to fourth PE devices PE1, PE2, PE3, and PE4 for transmission to the first to third CE devices CE1, CE2, and CE3 (and ultimately to the host devices connected thereto). Although the second and third CE devices CE2 and CE3 may receive single copies of the BUM traffic from their corresponding third and fourth PE devices PE3 and PE4, the first CE device CE1 could receive multiple copies of the same BUM traffic from both of the first and second PE devices PE1 and PE2. This could increase load on a network that is local to the first CE device CE1, and could result in poor performance at the host devices (which may receive multiple copies of the same BUM traffic).

In order to avoid a multi-homed CE device (e.g., the first CE device CE1 of FIG. 1) from receiving multiple copies of BUM traffic from the plurality of PE devices connected thereto, the PE devices may perform a designated forwarder (DF) election. Thus, only one of the PE devices servicing a given Ethernet segment (e.g., Ethernet segment ES1) is responsible for forwarding (or unblocking) BUM traffic, while the remaining PE devices also providing service to the Ethernet segment are required to drop (or block) the BUM traffic. The Internet Engineering Task Force (IETF) Request for Comments RFC 7432 provides a default procedure for performing DF election, referred to as service carving.

The service carving procedure of RFC 7432 also permits a possibility of electing different DFs for different VLANs or EVIs for a given Ethernet segment, which may help perform load balancing of multi-destination traffic that is destined to the given Ethernet segment.

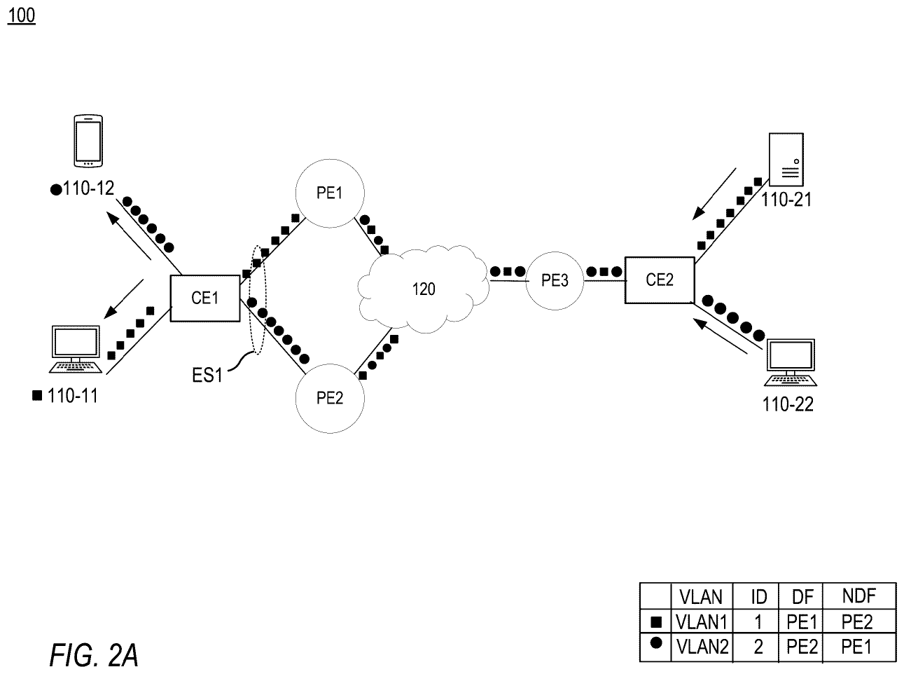

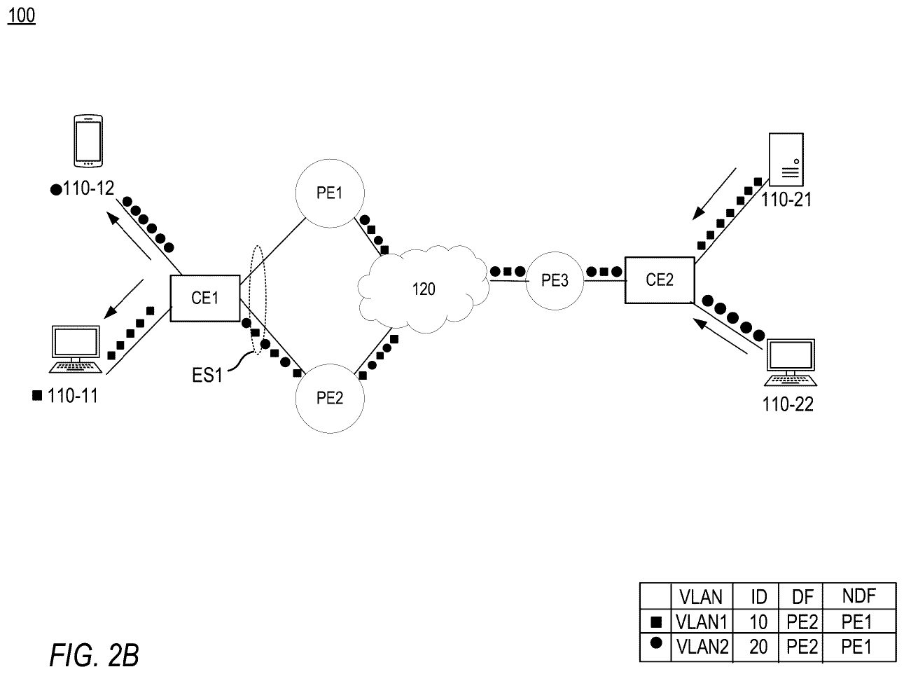

FIG. 2A is a block diagram providing further simplification of the network 100 according to the concepts described herein. As in FIG. 1, the first CE device CE1 is multi-homed with the first and second PE devices PE1 and PE2 via an Ethernet segment ES1. The first host device 110-11 and the fourth host device 110-21 may communicate traffic with each other via the first VLAN1. The second host device 110-12 and the fifth host device 110-22 may communicate traffic with each other via the second VLAN2. BUM traffic is being communicated on each of the first and second VLANs VLAN1 and VLAN2 from the fourth and fifth host devices 110-21 and 110-22, respectively, and the BUM traffic is destined for the first and second host devices 110-11 and 110-12.

As shown, the provider edge devices PE1 and PE2 may perform a DF election based on detecting that they are both part of the same Ethernet segment ES1 in order to determine which PE device (e.g., PE1 or PE2) will act as a DF for each VLAN VLAN1 and VLAN2 (or for each EVI).

A PE device (e.g., PE1), upon discovery of a connected Ethernet segment ES1, will advertise an auto-discovery route, and will start a hold-down timer to allow the reception of the auto-discovery routes from any other PE devices (e.g., PE2) connected to the same Ethernet segment. When the timer expires, each PE device separately builds an ordered list of addresses (e.g., IP addresses) of all the PE devices connected to the Ethernet segment (including itself) and discovered during the duration of the hold-down timer, in increasing numeric order. Every PE device is then given an ordinal indicating its position in the ordered list, starting with 0 as the ordinal for the PE device with the numerically lowest address. For simplicity, the auto-discovery route is a generic term used here to represent the combination of Type-4 route, the EAD-ES route and the EAD-EVI route that each PE device advertises to all other PE devices in the Ethernet-Segment. The combination of all these routes enables each PE device to know they all belong to the same Ethernet-segment and the list of VLANS configured in each PE device.

The ordinals are then used to determine which PE device is the DF for each VLAN or EVI observed on the Ethernet segment. If VLAN-based DF election is performed, the examined value is the identifier of the VLAN (the VLAN ID). The PE device serving as the DF for each VLAN is calculated according to a formula: (V mod N)=i, where V represents the VLAN ID, N is the number of PEs that are servicing the VLAN on the Ethernet segment on to which the CE is multi-homed, and ‘i’ is the ordinal of the PE device that is to serve as the DF for the VLAN.

Turning to the example of FIG. 2A, it is assumed that the first VLAN VLAN1 has a VLAN ID of 1 (V₁=1), and the second VLAN VLAN2 has a VLAN ID of 2 (V₂=2), and that each is the sole VLAN in its corresponding EVI. It is also seen that for the first CE device CE1 and the Ethernet segment ES1, there are 2 PE devices (PE1 and PE2) providing service thereto (i.e., N=2). It is further assumed that the addresses (e.g., IP addresses) of the PE devices PE1 and PE2 are such that the address of the second PE device PE2 is lower than the address of the first PE device PE1. Thus, the ordered list of PE devices is [0:PE2, 1:PE1].

The DF may then be determined for each VLAN. For the first VLAN VLAN1, the formula is (V₁ mod n)=(1 mod 2)=1, corresponding to PE1, For the second VLAN VLAN2, the formula is (V₂ mod n)=(2 mod 2)=0, corresponding to PE2. In this case, the first PE device PE1 is selected as the DF to forward BUM traffic for the first VLAN VLAN1 to the first CE device CE1, and it is the non-designated forwarder (NDF) for the second VLAN VLAN2. The second PE device PE2 is selected as the DF to forward to the first CE device CE1 the BUM traffic for the second VLAN VLAN2, and is the NDF for the first VLAN VLAN1.

Each PE device that is elected as the DF for a given VLAN/EVI unblocks multi-destination traffic in the egress direction toward the Ethernet segment for the Ethernet tags associated with that VLAN/EVI. All the NDF PE devices continue to drop multi-destination traffic (for the associated VLAN/EVIs) in the egress direction toward the Ethernet segment.

The present disclosure in part recognizes a drawback in the algorithm of RFC 7432 that the VLAN identifiers used to determine the DF for each VLAN/EVI may not be uniformly distributed. This is shown best in the example of FIG. 2B. As with FIG. 1 and FIG. 2A, the first CE device CE1 is multi-homed with the first and second PE devices PE1 and PE2 via an Ethernet segment ES1. The first host device 110-11 and the fourth host device 110-21 may communicate traffic with each other via the first VLAN1. The second host device 110-12 and the fifth host device 110-22 may communicate traffic with each other via the second VLAN2. BUM traffic is being communicated on each of the first and second VLANs VLAN1 and VLAN2 from the fourth and fifth host devices 110-21 and 110-22, respectively, and the BUM traffic is destined for the first and second host devices 110-11 and 110-12. However, in the example of FIG. 2B, it is assumed that the first VLAN VLAN1 has a VLAN ID of 10 (V₁=10), and the second VLAN VLAN2 has a VLAN ID of 20 (V₂=20), and that each is the sole VLAN in its corresponding EVI.

As with FIG. 2A, in FIG. 2B for the first CE device CE1 and the Ethernet segment ES1, there are 2 PE devices (PE1 and PE2) providing service thereto (i.e., N=2). Additionally, it is again assumed that the addresses (e.g., IP addresses) of the PE devices PE1 and PE2 are such that the address of the second PE device PE2 is lower than the address of the first PE device PE1. Thus, the ordered list of PE devices is [0:PE2, 1:PE1].

For the first VLAN VLAN1, the formula is (V₁ mod N)=(10 mod 2)=0, corresponding to PE2, For the second VLAN VLAN2, the formula is (V₂ mod N)=(20 mod 2)=0, also corresponding to PE2. In this case, the second PE device PE2 is selected as the DF to forward to the first CE device CE1 the BUM traffic for both the first VLAN VLAN1 and for the second VLAN VLAN2. Meanwhile, the first PE device PE1 is the non-designated forwarder (NDF) for both the first and second VLANs VLAN1 and VLAN2.

FIG. 2B shows that, in some scenarios and depending on the identifiers of the VLANs, the procedure of RFC 7432 may result in a single PE device being elected as the DF for all BUM traffic load for a given Ethernet segment, while other PE devices may be underutilized or completely un-utilized for BUM traffic. More generally, the procedure of RFC 7432 may result in an unbalanced distribution of BUM traffic load across the PE devices for a given Ethernet segment. This may result in decreased and inconsistent network performance, and in some situations may result in failure or outages, as the overloaded PE devices may not be able to handle the amount of traffic being provided from the network 120 for processing and forwarding to the multi-homed CE device.

Pursuant to embodiments of the present disclosure, methods and systems are provided in which designated forwarder (DF) elections may be performed that result in more efficient load balancing than the mechanism of RFC 7432. For example, each PE device servicing a given Ethernet segment may, in addition to generating an ordered list of PE devices, also generate an ordered list of EVIs or VLANs, in ascending order based on identifiers of the EVIs or VLANs. Each PE device may then use the ordered list of EVIs or VLANs to determine whether the PE device is to act as the DF for the EVI or VLAN.

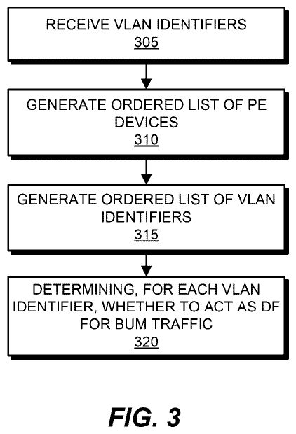

FIG. 3 is a flowchart illustrating operations of a method of performing a DF election according to some embodiments of the present disclosure. The method may include a first provider edge (PE) device receiving a plurality of virtual local area network (VLAN) identifiers (block 305). The plurality of VLAN identifiers may be received as part of a configuration process (e.g., received as input using a command line interface (CLI) and/or graphical user interface (GUI), received from a controller device (not shown) present on the network, or so on). Each VLAN identifier may identify a respective VLAN associated with an Ethernet Virtual Private Network (EVPN) instance (EVI).

The method may include the first PE device generating an ordered list of a plurality of PE devices that includes the first PE device (block 310). The generating of the ordered list of the plurality of PE devices may be performed responsive to initiation of a DF election process. For example, after receiving the plurality of VLAN identifiers, but not necessarily based on receiving the plurality of VLAN identifiers, the first PE device (e.g., PE1) may initiate a DF election, e.g., upon discovery of a connected Ethernet segment ES1. As discussed above, the first PE device may advertise an auto-discovery route, and may start a hold-down timer to allow the reception of the auto-discovery routes from any other PE devices (e.g., PE2) connected to the same Ethernet segment.

The method may further include the first PE device generating an ordered list (e.g., the list is ordered in increasing numeric order) of the VLAN identifiers (block 315). For example, each VLAN identifier may be given an ordinal indicating its position in the ordered list, starting with 0 as the ordinal for the VLAN identifier with the numerically lowest identifier. The generating of the ordered list of the VLAN identifiers may occur prior to, concurrently with, or subsequently to the generating of the ordered list of the PE devices. The ordered list will be generated after the timer expires.

The method may include the first PE device determining for each VLAN identifier in the ordered list of VLAN identifiers, whether the first PE device is to act as a designated forwarder (DF) for sending broadcast, unknown unicast or multicast (BUM) traffic associated with the VLAN identifier to a customer edge (CE) device (block 320). The CE device may be connected to each of the plurality of PE devices that includes the first PE device. The determining of whether the first PE device is to act as the DF for sending BUM traffic may be based on the position of each VLAN identifier within the ordered list of VLAN identifiers, the position of the first PE device in the ordered list of the plurality of PE devices, and/or based on the number of the plurality of PE devices that includes the first PE device.

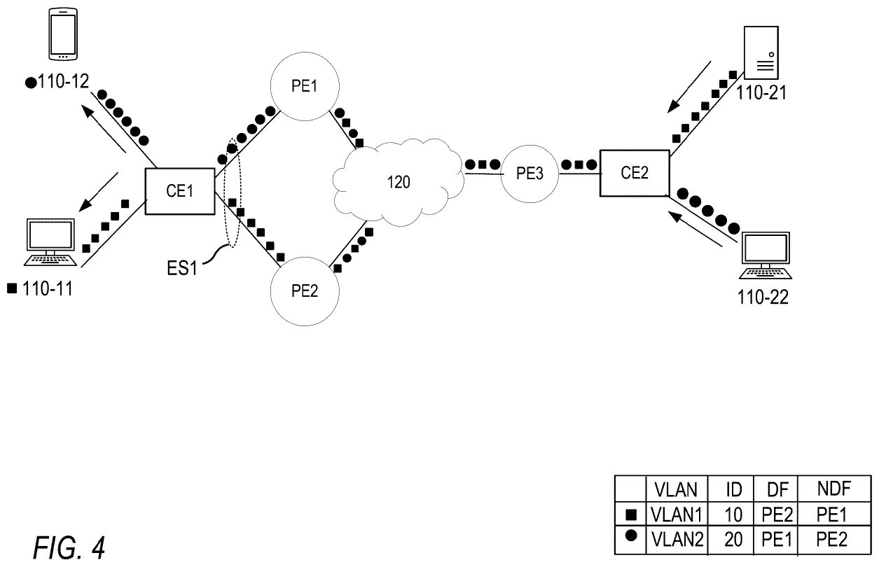

FIG. 4 is a block diagram of a simplified network 200 and illustrates aspects of some of the concepts described herein. As with FIGS. 1, 2A and 2B, the first CE device CE1 is multi-homed with the first and second PE devices PE1 and PE2 via an Ethernet segment ES1. The first host device 110-11 and the fourth host device 110-21 may communicate traffic with each other via the first VLAN1. The second host device 110-12 and the fifth host device 110-22 may communicate traffic with each other via the second VLAN2. BUM traffic is being communicated on each of the first and second VLANs VLAN1 and VLAN2 from the fourth and fifth host devices 110-21 and 110-22, respectively, and the BUM traffic is destined for the first and second host devices 110-11 and 110-12. As with FIG. 2B, it is assumed that the first VLAN VLAN1 has a VLAN ID of 10 (V₁=10), and the second VLAN VLAN2 has a VLAN ID of 20 (V₂=20), and that each is the sole VLAN in its corresponding EVI.

The first PE device PE1 and the second PE device PE2 may each receive (e.g., as part of a configuration command received from an external source or device) a list of VLANs [VLAN1, VLAN2] (which may be a list of VLAN identifiers) that are configured on the Ethernet segment ES1 (block 305 of FIG. 3). The first PE device PE1 may determine, for the list of VLANs, an ordered list of the VLAN identifiers (block 315 of FIG. 3). For example, as discussed above each VLAN identifier may be given an ordinal indicating its position in the ordered list, starting with 0 as the ordinal for the VLAN identifier with the numerically lowest identifier. Since first VLAN VLAN1 has a VLAN ID of 10 (V₁=10), and the second VLAN VLAN2 has a VLAN ID of 20 (V₂=20), the ordered list of VLAN identifiers may be [0: VLAN1, 1: VLAN2]. It will be appreciated that the VLAN identifiers may be actual VLAN identifiers or other information (e.g., hashes of the VLAN identifiers) that may be used to uniquely identify each of the VLANs.

As with FIGS. 2A and 2B, a DF election process may occur in the network of FIG. 4. For the first CE device CE1 and the Ethernet segment ES1, there are two PE devices (PE1 and PE2) providing service thereto (i.e., N=2). Additionally, it is again assumed that the addresses (e.g., IP addresses) of the PE devices PE1 and PE2 are such that the address of the second PE device PE2 is lower than the address of the first PE device PE1. Thus, the ordered list of PE devices generated (block 310 of FIG. 3) during the DF election process is [0:PE2, 1:PE1].

Each PE device may then determine for each VLAN identifier in the ordered list of VLAN identifiers, whether the determining PE device is to act as a DF for sending BUM traffic to the first CE device CE1 (block 320 of FIG. 3).

In some embodiments, each PE device may examine and perform DF/NDF assignment by iteration using the ordered list of VLAN identifiers and the ordered list of PE devices, repeating through the latter as needed. For example, the first VLAN VLAN1 having the first position in the ordinal list of VLAN identifiers (ordinal position 0) may be assigned to the PE having the first position in the ordered list of PE devices (ordinal position 0), corresponding to the second PE device PE2. The second VLAN VLAN2 having the second position in the ordinal list of VLAN identifiers (ordinal position 1) may be assigned to the PE having the second position in the ordered list of PE devices (ordinal position 1), corresponding to the first PE device PE1. If a third VLAN (e.g., VLAN3) were present in the third position in the ordinal list of VLAN identifiers (ordinal position 2), it may be assigned to the PE having the first position in the ordered list of PE devices (ordinal position 0), corresponding to the second PE device PE2. More simply, in some embodiments, the position of a given VLAN identifier in the ordered list of VLAN identifiers mod the total number of PE devices may equal the position of the PE device that is to serve as the DF for the given VLAN identifier.

Thus, in the above example, the ordinal values of the PE devices will be [0:PE2, 1:PE1] and the ordinal values of the VLANs will be [0: VLAN1, 1: VLAN2]. For VLAN1 (at ordinal 0) the second PE device PE2 (also at ordinal 0) is assigned as DF. The first PE device PE1 (at ordinal 1) is assigned as NDF. For VLAN2 (at ordinal 1), the first PE device PE1 (at ordinal 1) is assigned as DF. The second PE device PE2 (at ordinal 0) is assigned as NDF. If there is a third VLAN VLAN3 having, for example, VLAN-ID 30 (which will be at ordinal 2), the second PE device PE2 (at ordinal 0) is assigned as DF and the first PE device PE1 (at ordinal 1) is assigned as NDF. Likewise, if there is a fourth VLAN VLAN4 having, for example, VLAN-ID 40 (which will be at ordinal 3), the first PE device PE1 (at ordinal 1) is assigned as DF and the second PE device PE2 (at ordinal 0) is assigned as NDF.

In case of dual-homing (two PE devices in the Ethernet-segment ES1), the following result will be observed at the end of this procedure:

The second PE device PE2 (at ordinal 0) is assigned as DF for all VLANs that have even numbered ordinal values like 0, 2, 4, etc., and assigned as NDF for all VLANs that have odd numbered ordinal values like 1, 3, 5, etc.

The first PE device PE1 (at ordinal 1) is assigned as DF for all VLANs that have odd numbered ordinal values like 1, 3, 5, etc., and assigned as NDF for all VLANs that have even numbered ordinal values like 0, 2, 4, etc.

In this manner, all VLANs will be evenly distributed between the first and second PE devices PE1 and PE2 ensuring efficient load-balancing (service carving) of ingressing BUM traffic at the first and second PE device PE1 and PE2 towards the first client device CE1. This kind of efficient service carving is not always possible with the approach proposed in RFC-7432. Moreover, if there are more than two PE devices, say first, second and third PE devices PE1, PE2 and PE3 in the Ethernet-segment ES1, the same approach is followed as described above.

Assume, for example, that the first through third PE devices PE1, PE2 and PE3 in the Ethernet-segment ES1 have ordinal values as follows: [0:PE2, 1:PE1, 2:PE3] and there are six VLANs with ordinal values as follows: [0: VLAN1, 1: VLAN2, 2: VLAN2, 3: VLAN3, 4: VLAN4, 5: VLAN6]. Then, the second PE device PE2 becomes DF for VLANs with ordinal values 0, 3; and the first PE device PE1 becomes DF for VLANs with ordinal values 1, 4; and the third PE device PE3 becomes DF for VLANs with ordinal values 2, 5.

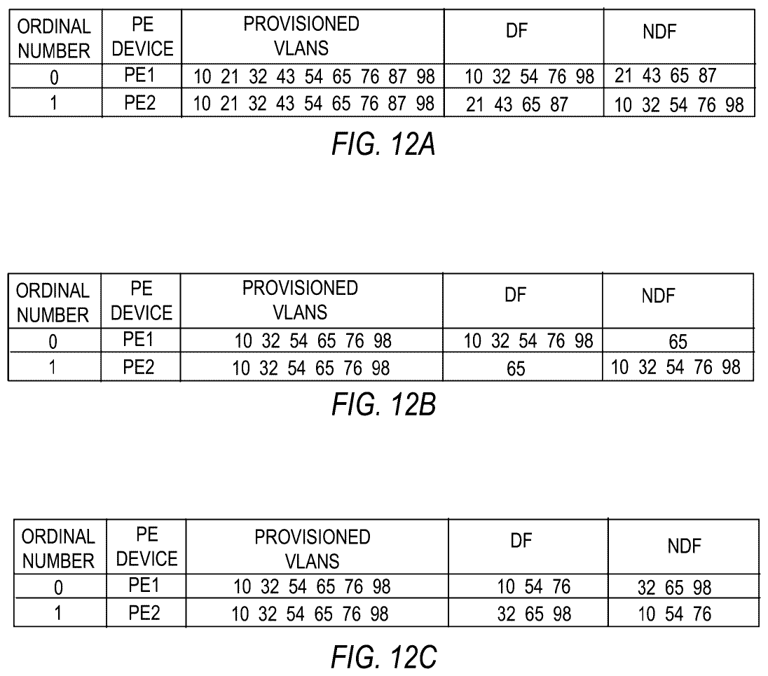

FIG. 12A provides another example in which traffic is being communicated through a first CE device CE1 is using a larger number of VLANs having VLAN IDs 10, 21, 32, 43, 54, 65, 76, 87, 98. As with FIG. 4, the first CE device CE1 is multi-homed with the first and second PE devices PE1 and PE2 via an Ethernet segment ES1. FIG. 12A shows the assignments of the first and second PE devices PE1 and PE2 as DF and NDF for the various VLANs using the above-described techniques.

In some embodiments, a new VLAN may be configured (via CLI) in addition to the already existing set of VLANs in the PE devices.

If a new VLAN is configured, each PE device should satisfy three rules or conditions before the PE device is made DF or NDF for the new VLAN:

Rule (1): The number of VLANs that the examining PE device is acting as DF for is equal to or less than the number of VLANs that the examining PE device is not acting as DF for (i.e., is NDF for the VLAN). In other words, the first PE devices DF count≤the PE devices NDF count. Stated differently, #DF_{PE}≤#NDF_{PE}.

Rule (2): The number of VLANs that the examining PE device is acting as DF for is equal to or less than half the number of VLANs in the ordered list of VLAN identifiers (excluding the new VLAN). In other words, PE1's DF count≤Half of the total VLAN Count in the Ethernet segment (excluding the new VLAN). Stated differently, (#DF_{PE1}≤(#TOTAL_VLANs/2).

Rule (3): The examining PE device is first in the ordinal list (PE with ordinal value as 0 is the first in the ordinal list) for which rules (1) and (2) are true.

Rule (3) acts as a tie-breaker rule in instances where two or more PE devices satisfy Rule (1) and Rule (2).

A brief example is presented for the first and second VLANs VLAN1 and VLAN2, with the assumption that no prior DF election has occurred (i.e., the first and second PE devices are not established to be acting as DF for any VLANs).

FIG. 4 illustrates the first set of two VLANs, VLAN1 with VLAN-ID 10 and VLAN2 with VLAN-ID 20 configured in the Ethernet-segment ES1. The first PE device PE1 assigns the ordinal numbers for the list of PE devices (PE1 and PE2) configured in the Ethernet-segment ES1 based on the approach proposed in RFC-7432. Based on this approach, the first PE device PE1 is assigned an ordinal value of 1 and the second PE device PE2 is assigned an ordinal value of 0. In addition to what is proposed in RFC-7432, the configured VLANs with VLAN-ID 10 and 20 are arranged in increasing order of their values (first 10 and followed by 20) and assigned ordinal numbers sequentially. With this approach, VLAN-ID 10 is assigned an even numbered ordinal value of 0 and VLAN-ID 20 is assigned an odd numbered ordinal value of 1. Next, the first and second PE devices PE1 and PE2 execute DF election (for VLAN-IDs 10 and 20) to designate themselves as DF and NDF based on their assigned ordinal numbers. As explained in above, the second PE device PE2 with an ordinal value of 0 is assigned as DF for VLAN-ID 10 (having ordinal value 0) and is assigned as NDF for VLAN-ID 20 (having ordinal value 1). The first PE device PE1 with an ordinal value of 1 is assigned as DF for VLAN-ID 20 (having ordinal value 1) and is assigned as NDF for VLAN-ID 10 (having ordinal value 0).

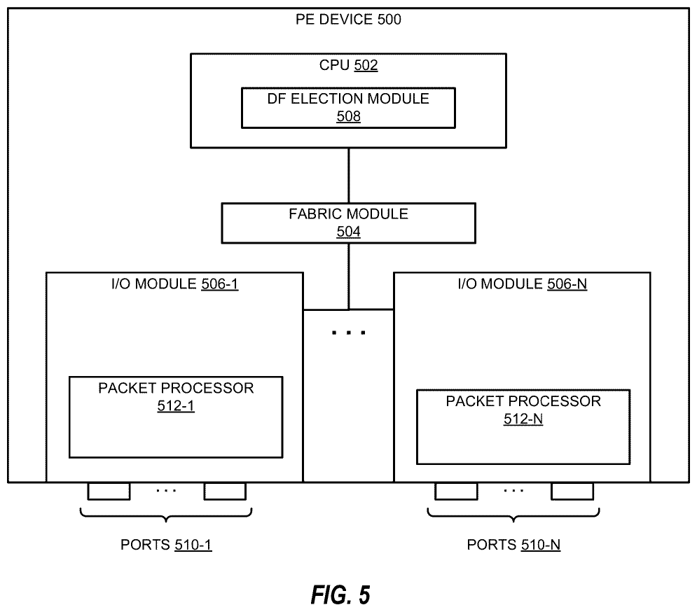

Subsequent to completion of the DF election process, the first and second PE devices PE1 and PE2 may install or modify data processing rules in order to forward or drop BUM traffic according to the results of the DF election. FIG. 5 illustrates a block diagram of computer networking device according to some of the concepts described herein. Aspects of the computer networking device 500 may be used in implementations of the first and second PE devices PE1 and PE2, the CE devices (e.g., CE1), and/or other devices herein.

As shown in FIG. 5, the computer networking device 500 includes one or more CPUs 502, at least one I/O module 506, and a fabric module 504.

The one or more CPUs 502 are configured to manage and/or control the operation of the computer networking device 500. Each CPU 502 can be a general-purpose processor, such as a PowerPC, Intel, AMD, or ARM-based processor that operates under the control of software stored in an associated memory (not shown in FIG. 5). The software may include a DF election module 508 that is configured according to the concepts described herein. Additional functionality may be present in the processor and/or memory, but may not be shown in the block diagram of FIG. 5 to simplify the illustration. The fabric module 504 and I/O modules 506 collectively represent the forwarding plane of the computer networking device 500. The fabric module 504 may be configured to interconnect the various other modules of the computer networking device 500. Each I/O module 506 can include one or more input/output ports 510 that are used by the computer networking device 500 to send and receive data and control packets. Each I/O module 506 can also include a packet processor 512. The packet processors 512 may be hardware processing components (e.g., an ASIC or Field Programmable Gate Array (FPGA)) that can make wire speed decisions on how to handle incoming or outgoing packets, data frames, transmission units or the like (and are thus not limited to “packets”).

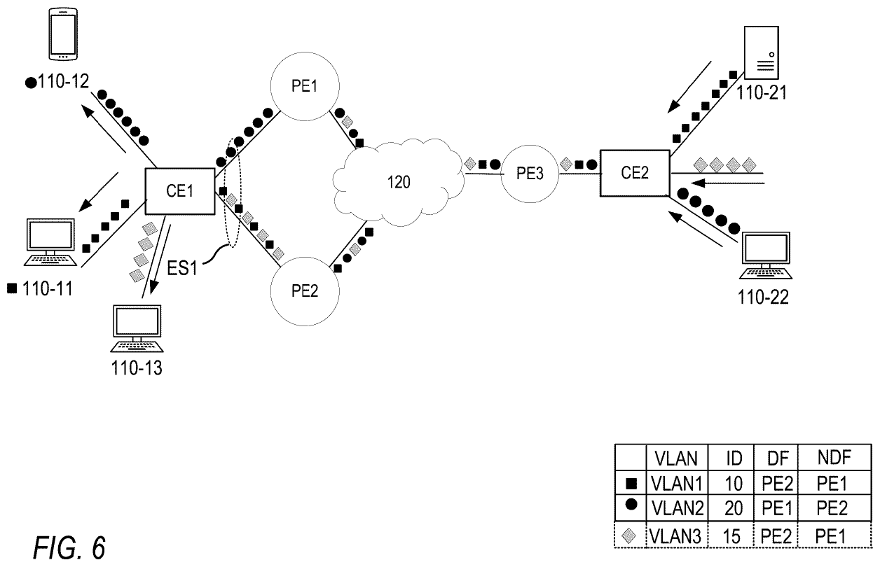

FIGS. 6, 7, 8, 9A, 9B, and 10 are block diagrams of simplified networks and illustrate aspects of some of the concepts described herein.

FIG. 6 illustrates an example in which a new VLAN (e.g., a third VLAN VLAN3) is added to the list of VLANs after the first and second PE devices PE1 and PE2 have been assigned as the DFs for VLANs VLAN2 and VLAN1, respectively. The third VLAN VLAN3 may be associated with BUM traffic that is received by the first and second PE devices PE1 and PE2 and is destined for a host device 110-13 that is connected to the first CE device CE1. Although the traffic is shown as originating from an unseen device connected the second CE device CE2, it is understood that this is merely an example and for illustration only, and may enter the network 120 from another source (e.g., via a different PE device than the third PE device PE3). The third VLAN VLAN3 may have an identifier that is not the highest or greatest in the list of VLAN identifiers. In some embodiments, a DF election process according to the methods described herein may yield a DF being determined for the newly-added VLAN without disturbing or churning results of one or more already-conducted DF elections.

In some embodiments, for the newly-added VLAN identifier, both the first and second PE devices PE1 and PE2 should examine the three rules or conditions discussed above and then decide on the DF/NDF role for the newly added VLAN3 with VLAN-ID 15. An example is provided and explained above using the already-conducted DF election results of FIG. 4. The first and second PE devices PE1 and PE2 apply the three above-discussed rules to decide who will be the DF for the new VLAN with VLAN-ID 15. The first PE device PE1 identifies that Rule (1) is TRUE (#DF_{PE1}≤#NDF_{PE1}, or 1≤1), followed by (Rule 2), which is also TRUE (#DF_{PE1}≤[#TOTAL_VLANS/2]), or (1≤[2/2] or 1≤1). However, since Rules (1) and (2) are TRUE, Rule (3) is examined. The first PE device PE1 is not the first (or lowest) in the ordinal list of PE devices for which Rules (1) and (2) are true. Thus, Rule (3) is FALSE, and the first PE device PE1 determines that it is not the DF for the third VLAN VLAN3 with value 15. With respect to the third VLAN VLAN3, the second PE device PE2 examines and identifies that Rule (1) is TRUE (#DF_{PE2}≤#NDF_{PE2}) or (1≤1), and that Rule (2) is also TRUE (#DF_{PE2}≤[#TOTAL_VLANS/2]) or (1≤[2/2]) or (1≤1). However, since Rules (1) and (2) are TRUE, Rule (3) is examined. The second PE device PE2 is also the first in the ordinal list of PE devices for which Rules (1) and (2) are TRUE. Thus Rule (3) is TRUE, and the second PE device PE2 determines that it is the DF for the third VLAN VLAN3.

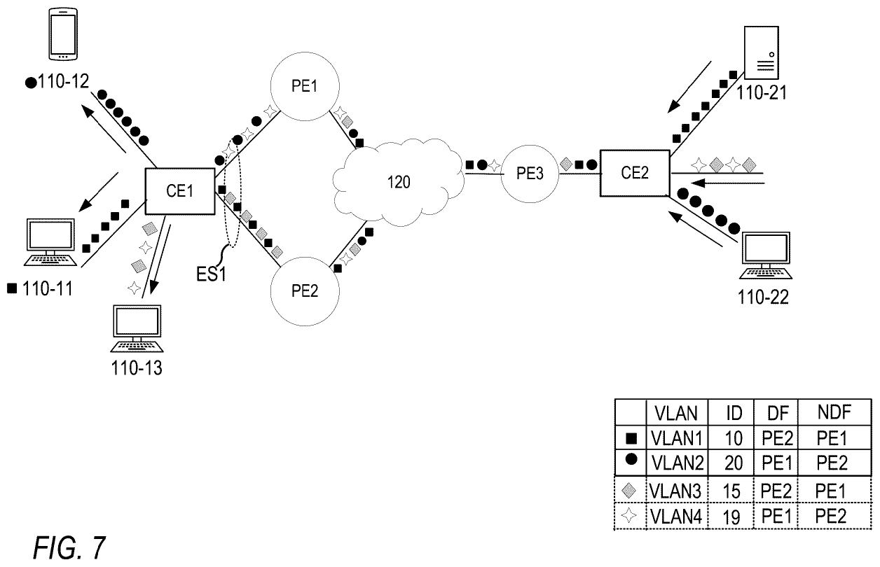

FIG. 7 illustrates an example in which multiple VLANs (e.g., a third VLAN VLAN3 and a fourth VLAN VLAN4) are concurrently added to the list of VLANs. The third VLAN VLAN3 and fourth VLAN VLAN4 may be associated with BUM traffic that is received by the first and second PE devices PE1 and PE2 and is destined for a host device 110-13 that is connected to the first CE device CE1. Although the traffic for the third VLAN VLAN3 and the fourth VLAN VLAN4 is shown as originating from an unseen device connected the second CE device CE2, again that this is merely an example and for illustration only, and may enter the network 120 from another source (e.g., via a different PE device than the third PE device PE3). The third VLAN VLAN3 and the fourth VLAN VLAN4 may have VLAN identifiers that are interspersed with the VLAN identifiers of the first and second VLANs VLAN1 and VLAN2. In some embodiments, a DF election process according to the methods described herein may yield a DF being determined for the newly-added VLAN without disturbing or churning results of one or more already-conducted DF elections.

In some embodiments, the list of newly-added multiple VLAN identifiers (e.g., the plurality of newly-added VLAN identifiers) should be treated as a separate and unmerged list that is independent from the already-considered VLAN list. An example was provided above using the already-conducted DF election results of FIG. 4 (where the first PE device PE1 is the DF for the second VLAN VLAN2 and where the second PE device PE2 is the DF for the first VLAN VLAN1). The above-discussed approach was followed as there were two or more VLANs (VLAN-IDs 10 and 20). The same approach described above with reference to FIG. 4 is again followed for the new set of distinct VLANs as there are two or more newly configured VLANs. The VLANs (VLAN3 with VLAN-ID 15 and VLAN4 with VLAN-ID 19) are arranged in increasing order and assigned ordinal numbers as done before. As a result, VLAN3 is assigned ordinal value 0 and VLAN4 is assigned ordinal value 1.

The first PE device PE1 already has the ordinal numbers assigned for the list of PE devices (PE1 and PE2) based on the approach proposed in RFC-7432. Based on this approach, the first PE device PE1 has an ordinal value of 1 and the second PE device PE2 has an ordinal value of 0. The first and second PE devices PE1 and PE2 execute DF election (for VLAN-IDs 15 and 19) to designate themselves as DF and NDF based on their assigned ordinal numbers. As explained above, the second PE device PE2 with an ordinal value of 0 is assigned as DF for VLAN-ID 15 (having even numbered ordinal value 0) and as NDF for VLAN-ID 19 (having odd numbered ordinal value 1). The first PE device PE1 with an ordinal value of 1 is assigned as DF for VLAN-ID 19 (having odd numbered ordinal value 1) and as NDF for VLAN-ID 15 (having even numbered ordinal value 0).

For both the examples of FIGS. 6 and 7, performing the DF election process on the newly-added VLANs results in the first and second PE devices PE1 and PE2 handling BUM traffic for different VLANs than if the method of FIG. 3 were performed for all configured VLANs. For example, in FIG. 7, if the method of FIG. 3 were performed for all configured VLANs, an ordered list of VLANs based on VLAN identifiers would be [0: VLAN1, 1: VLAN3, 2: VLAN2, 3: VLAN4], with the second PE device PE2 acting as DF for the first and second VLANs VLAN1 and VLAN2, and the first PE device PE1 acting as DF for the third and fourth VLANs VLAN3 and VLAN4.

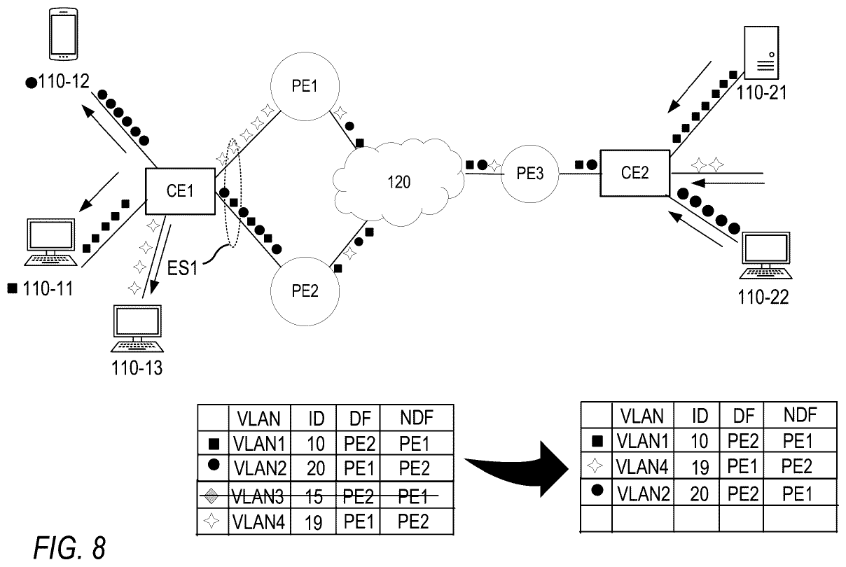

FIG. 8 illustrates an example in which a VLAN (e.g., a third VLAN VLAN3) is removed, and traffic is no longer tagged with the VLAN identifier. In some embodiments, the remaining VLANs may be re-arranged in ascending order and a complete DF election may or may not be performed for the remaining VLANs. This may or may not change the DF/NDF role of the PE device for each of the VLANs. The VLANs may be re-ordered and assigned new ordinal numbers and the DF re-election may be performed provided if the difference between the DF and NDF count of any PE device in the Ethernet-segment goes beyond a pre-configured threshold value. For example, given a threshold value is four, if a PE device is functioning as DF for seven VLANs and as NDF for two VLANs, then this can trigger a DF re-election with new ordinal values being assigned for all of the VLANs. The DF re-election will take place as described above with reference to FIG. 4. This kind of DF and NDF count difference in the PE devices (PE1 and PE2) may occur if few VLANs get untagged from the VLAN identifier, resulting in one PE device functioning as DF for more VLANs and NDF for fewer VLANs. This again results in unfair load-balancing (service-carving) of BUM traffic between the first and second PE devices PE1 and PE2. By applying the threshold value and re-triggering the DF election, service carving will be restored. The threshold value may be judiciously determined by the operator. FIGS. 12B-12C illustrate another example as to how the DF/NDF assignments may be adjusted after one or more VLANs are de-provisioned. In the example of FIGS. 12B-12C, it is assumed that, prior to the de-provisioning, the PE devices, VLANs and DF and NDF assignments are as shown in FIG. 12A. It is then assumed that the VLANs having VLAN IDs 21, 43 and 87 are de-provisioned from both the first and second PE devices PE1 and PE2. As shown in FIG. 12B, after the three VLANs are de-provisioned, the first PE device PE1 acts as DF for five VLANs, whereas the second PE device PE2 acts as DF for a single VLAN, indicating poor load balancing. Assuming that the threshold value for the difference between DF and NDF count is three, a re-balancing will occur since the threshold will have been exceeded. FIG. 12C shows the DF/NDF assignments that will occur after the DF election is re-triggered according to the above-described techniques according to embodiments of the present invention.

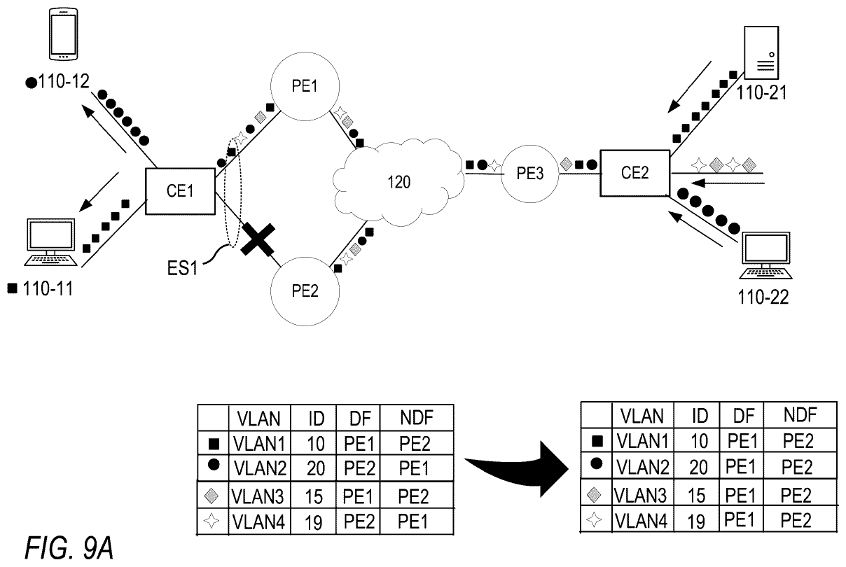

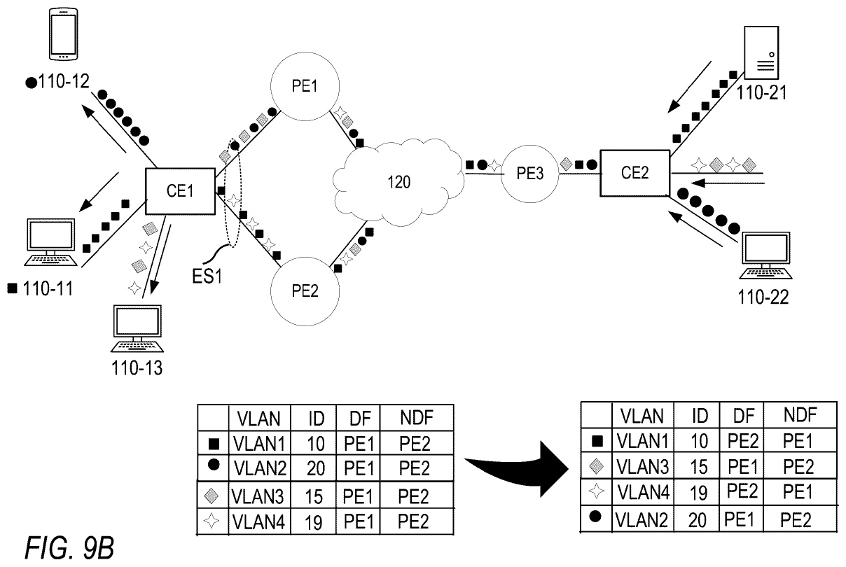

FIGS. 9A and 9B illustrates an example in which a PE device (e.g., the second PE device PE2) becomes unavailable after it has been assigned as the DF for one or more VLANs because, for example, the PE device crashes or a link in an Ethernet segment between the PE device and an associated CE device goes down. In this example, the second PE device PE2 is shown as becoming unavailable because the link connecting the second PE device PE2 to the first client device CE1 has gone down.

When the second PE device PE2 becomes unavailable, a new election process is performed. Since, in this example, there is only one remaining PE device (namely the first PE device PE1) connected to the first client device CE1, the first PE device PE1 becomes the DF for all of the VLANs, as is shown in the tables in FIG. 9A. As shown in FIG. 9B, at a later time the second PE device PE2 may become available again (here because the link connecting the second PE device PE2 to the first client device CE1 is restored). When the second PE device PE2 becomes available again it shares this information with the other PE devices. The renewed availability of the second PE device PE2 then triggers the election process to be performed again, resulting in a new set of assignments as to which PE devices are the DFs for the different VLANs, as shown by the tables in FIG. 9B. Note, that since at the time of this election process the first PE device PE1 is the DF for all of the VLANs, the resulting assignment of PE devices as DFs for the different VLANs shown in the right-hand table of FIG. 9B differs from the original assignment of PE devices as DFs for the different VLANs as shown in the left-hand table of FIG. 9A.

When the second PE device PE2 announces itself as available to other PE devices (here the first PE device PE1) for all VLANs, all of the PE devices (i.e., PE1 and PE2) assign ordinal values to all the VLANs (0: VLAN1, 1: VLAN3, 2: VLAN4, 3: VLAN2) as described above. Next, the PE devices assign themselves with ordinal values (ending up with: 0:PE2, 1:PE1) and the DF roles are assigned for each VLAN. After the DF election, the second PE device PE2 with ordinal value of 0, becomes DF for VLANs VLAN1 and VLAN4, and the first PE device PE1 becomes DF for VLANs VLAN3 and VLAN2. This is as shown in FIG. 9B.

The present disclosure is based on part on recognition of another potential problem in the mechanisms of RFC 7432 and in EVPN implementations. In some situations, a plurality of PE devices servicing an Ethernet segment (ES) and a multi-homed CE device can receive BUM traffic from the provider network 120 (and from remote PE devices) before DF election has been completed by the PEs of the ES. This can happen for several different reasons. First, configuration settings in the PE devices across the provider network 120 may be unsynchronized. Second, the DF hold-down timer for the PE devices to discover other PE devices connected to the ES and perform DF election may not have elapsed or completed. Third, in some large scale environments (e.g., where a large number of PE devices, a large number of EVIs, and/or a large number of VLANs are present) the DF election process may be relatively lengthy, and DF election may not yet be completed for a EVI or VLAN even though BUM traffic for the EVI or VLAN has been received. Fourth, the DF election process may be completed but not yet programmed at a packet processor or at a data plane level. Each of these (and other) events and conditions may be dynamic in nature.

RFC 7432 provides that, prior to the completion and/or installation of a DF for the ES to handle BUM traffic for an EVI or VLAN, all PE devices must act as a NDF and drop BUM traffic, resulting in a complete traffic outage, which is undesirable. An alternative is that each PE device acts as a DF and forwards BUM traffic, resulting in multiple copies of the same BUM traffic being received at the CE device and potentially at host devices connected thereto, which is also undesirable.

Accordingly, some aspects of the present disclosure provide systems and devices in which the above undesirable scenarios that stem from an uncompleted or unperformed election of a DF for an EVI or VLAN are mitigated. A first of the plurality of PE devices servicing a Ethernet segment may be selected and configured to act as a default or static DF until a DF election is completed and the results thereof are installed.

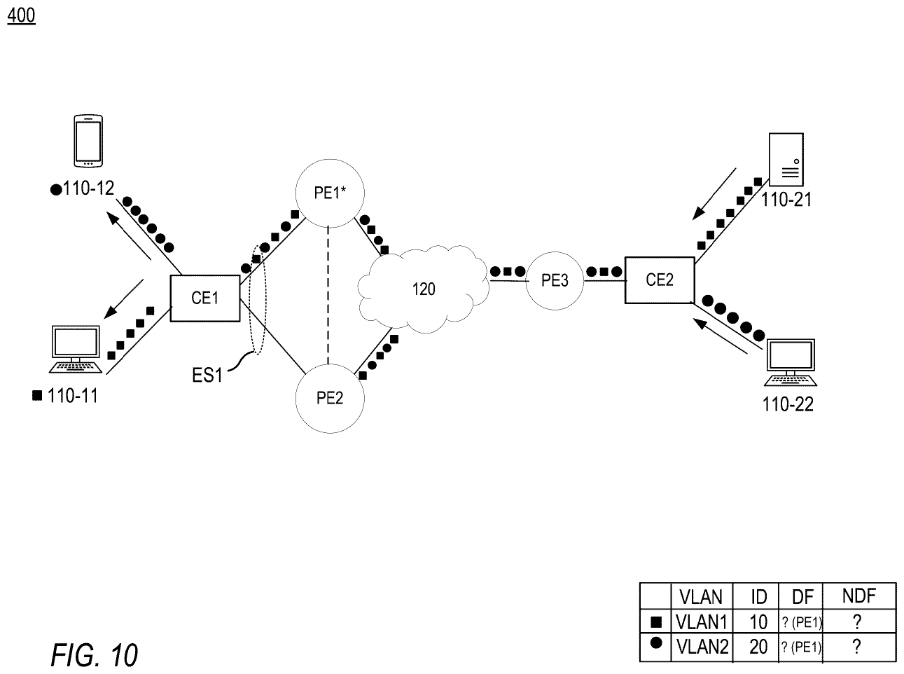

FIG. 10 illustrates this approach, which is to have only one of the plurality of PE devices forwarding VLAN-tagged BUM traffic over an Ethernet segment ES, while the remainder of the PE devices block such VLAN-tagged BUM traffic. In other words, prior to the completion of the elections of a DF for each EVI or VLAN, a single one of the PE devices may perform the DF functionality for all of the EVIs and VLANs. Once a DF election is performed and results are available for all VLANs and EVIs, BUM traffic forwarding is performed as discussed above with the elected PE device for each VLAN forwarding the BUM traffic for that VLAN.

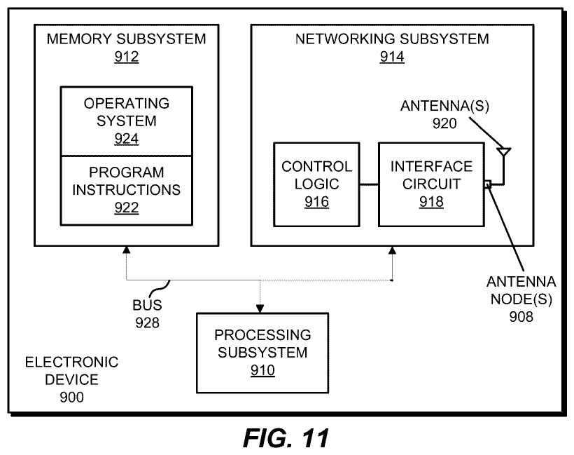

FIG. 11 is a block diagram illustrating an example electronic device 900 in accordance with some embodiments. Examples of electronic devices 900 may be the CE devices, PE devices, and host devices described with reference to FIGS. 1-10. The electronic device 900 includes a processing subsystem 910, a memory subsystem 912, and a networking subsystem 914. Processing subsystem 910 includes one or more devices configured to perform computational operations. Memory subsystem 912 includes one or more devices for storing data and/or instructions. In some embodiments, the instructions may include an operating system and one or more program modules which may be executed by processing subsystem 910.

Networking subsystem 914 includes one or more devices configured to couple to and communicate on a wired (i.e., to perform network operations), including: control logic 916 and an interface circuit 918, and optionally one or more antennas 920 and/or antenna nodes 908. Networking subsystem 914 includes processors, controllers, and/or other devices used for coupling to, communicating on, and handling data and events for each supported networking system. Note that mechanisms used for coupling to, communicating on, and handling data and events on the network for each network system are sometimes collectively referred to as a “network interface” for the network system. Electronic device 900 may use the mechanisms in networking subsystem 914 for transmitting packets to other devices and for receiving packets from other devices.

Processing subsystem 910, memory subsystem 912, and networking subsystem 914 are coupled together using bus 928. Bus 928 may include an electrical, optical, and/or electro-optical connection that the subsystems can use to communicate commands and data among one another.

The operations performed in the communication techniques according to embodiments of the present invention may be implemented in hardware or software, and in a wide variety of configurations and architectures. For example, at least some of the operations in the communication techniques may be implemented using program instructions 922, operating system 924 (such as a driver for interface circuit 918) or in firmware in interface circuit 918. Alternatively, or additionally, at least some of the operations in the communication techniques may be implemented in a physical layer, such as hardware in interface circuit 918.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an.” and “the” are intended to include the plural forms as well, unless the context clearly indicates otherwise. It will be further understood that the terms “comprises,” “comprising,” “includes,” and/or “including,” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A method for a first provider edge (PE) device to determine if it will act as a designated forwarder (DF) for each of a plurality of virtual local area networks (VLANs), the method comprising:
receiving, at the first PE device, a plurality of VLAN identifiers, each VLAN identifier identifying a respective one of the plurality of VLANs;
generating an ordered list of the VLAN identifiers; and
determining, for each VLAN, whether the first PE device is to act as the DF for forwarding traffic of the VLAN that is within a certain class of traffic to a customer edge (CE) device, where the CE device is connected to a plurality of PE devices that includes the first PE device, and the determining is based on a position of each VLAN identifier within the ordered list and based on a number of PE devices in the plurality of PE devices.

2. The method of claim 1, the method further comprising generating an ordered list of the PE devices in the plurality of PE devices.

3. The method of claim 2, wherein the determining is further based on the position of the first PE device in the ordered list of the PE devices in the plurality of PE devices.

4. The method of claim 1, wherein the certain class of traffic includes at least one of broadcast traffic, unknown unicast traffic and multicast traffic (BUM traffic).

5. The method of claim 1, wherein the class of traffic includes all three of broadcast traffic, unknown unicast traffic and multicast traffic (BUM traffic).

6. The method of claim 5, wherein the BUM traffic is received at each PE device in the plurality of PE devices.

7. The method of claim 1, wherein each of the plurality of VLANs is associated with an Ethernet Virtual Private Network (EVPN) instance.

8. A method for a first provider edge (PE) device that is already acting as a designated forwarder (DF) of broadcast traffic, unknown unicast traffic and multicast traffic (BUM traffic) for at least one virtual local area network (VLAN) to a customer edge (CE) device to determine if it will act as a DF for one or more additional VLANs to the CE device, where the CE device is connected to a plurality of PE devices that includes the first PE device, the method comprising:
determining if the first PE device, when acting as a selected one of the plurality of PE devices, satisfies a first rule, where the first rule is satisfied if a number of the plurality of VLANs for which the selected one of the plurality of PE devices is presently assigned as the DF is equal to or less than a number of the plurality of VLANs for which the selected one of the plurality of PE devices is not acting as DF;
determining if the first PE device, when acting as the selected one of the plurality of PE devices, satisfies a second rule, where the second rule is satisfied if the number of the plurality of VLANs for which the selected one of the plurality of PE devices is acting as DF for is equal to or less than a half of the total number of VLANs in the plurality of VLANs; and
determining if the first PE device is the lowest PE device in an ordinal list of the plurality of PE devices that satisfies both the first rule and the second rule.

9. The method of claim 8, the method further comprising assigning the first PE device as the DF of BUM traffic for the VLAN corresponding to a first VLAN identifier in an ordered list of VLAN identifiers in response to determining that the first PE device is the lowest PE device in an ordinal list of the plurality of PE devices that satisfies both the first rule and the second rule.

10. A method of forwarding traffic to a client edge (CE) device, the method comprising:
using an ordered list of virtual local area network (VLAN) identifiers, where each VLAN identifier corresponds to a respective one of a plurality of VLANs, to assign, for each of the plurality of VLANs, one of a plurality of provider edge (PE) devices that are connected to the CE device to forward traffic that is within a class of traffic to the CE device.

11. The method of claim 10, wherein the class of traffic includes at least one of broadcast traffic, unknown unicast traffic and multicast traffic.

12. The method of claim 10, wherein the class of traffic includes all three of broadcast traffic, unknown unicast traffic and multicast traffic.

13. The method of claim 10, wherein the traffic in the class of traffic is received at each of the PE devices that are connected to the CE device.

14. The method of claim 10, wherein each of the plurality of PE devices determines whether it is assigned to forward the class of traffic to the CE device for each of the plurality of VLANs.

15. The method of claim 10, further comprising generating an ordered list of the plurality of PE devices, and using the ordered list of plurality of PE devices in assigning, for each of the plurality of VLANs, one of the plurality of PE devices to forward a class of traffic to the CE device.

16. The method of claim 10, wherein each of the plurality of VLANs is associated with an Ethernet Virtual Private Network (EVPN) instance.
